(19) United States
(12) Patent Application Publication
(10) Pub. No.: US 2024/0128000 A1
(43) Pub. Date: Apr. 18, 2024

(54) MAGNETIC, FUNCTIONALIZED POLYMER SUBSTRATES FOR RADIOFREQUENCY APPLICATIONS

(71) Applicant: THUERINGISCHES INSTITUTE FUER TEXTILE- UND KUNSTOSTOFF-FORSCHUNG E.V., Rudolstadt (DE)

(72) Inventors: Günther PFLUG, Rudolstadt (DE); Michael GLADITZ, Saalfeld (DE); Stefan REINEMANN, Rudolstadt (DE)

(73) Assignee: THUERINGISCHES INSTITUTE FUER TEXTILE- UND KUNSTOSTOFF-FORSCHUNG E.V., Rudolstadt (DE)

(21) Appl. No.: 18/479,190

(22) Filed: Oct. 2, 2023

(30) Foreign Application Priority Data
Oct. 7, 2022 (DE) 10 2022 125 940.4

(51) Int. Cl. H01F 1/34; C08J 3/205; C08K 9/04; H01Q 1/40

(52) U.S. Cl. CPC H01F 1/34; C08J 3/2053; C08K 9/04; H01Q 1/40; C08J 2345/00; C08J 2355/02; C08K 2201/005; C08K 2201/01

(57) ABSTRACT

The invention relates to magnetodielectric polymer composites with increased refractive index and greatly reduced attenuation losses for the miniaturization of antennas in the MHz and bordering GHz frequency range, where through the use of a highly branched polymer compound in the polymer concerned, the magnetic filler component is more efficiently dispersed during processing and is also better incorporated in a 0-3 structure with the surrounding polymer matrix by virtue of the spacer function of the highly branched polymer compound.

### CROSS-REFERENCE TO RELATED APPLICATIONS

This application claims priority to German Patent Application 10 2022 125 940.4 filed Oct. 7, 2022, which is hereby incorporated herein by reference in its entirety.

### FIELD OF THE INVENTION

The patent describes magnetodielectric polymer composites with increased refractive index and greatly reduced attenuation losses for the miniaturization of antennas in the MHz and bordering GHz frequency range, where through the use of a highly branched polymer compound in the polymer concerned, the magnetic filler component is more efficiently dispersed during processing and is also better incorporated in a 0-3 structure with the surrounding polymer matrix by virtue of the spacer function of said compound.

### BACKGROUND OF THE INVENTION

Magnetodielectric polymer composites are heterogeneous mixtures of one or more magnetic filler components in a dielectric plastics matrix, so integrating properties of both magnetic and dielectric materials in the plastics.

In line with the studies by Mosallaei and Sarabandi, “Magneto-Dielectrics in Electromagnetics: Concepts and Applications” in IEEE Transactions on Antennas and Propagation Vol. 52, No. 6 (2004) pp. 1558-1569, and by Juuti and Teirikangas, “Thermoplastic 0-3 Ceramic-Polymer Composites with Adjustable Magnetic and Dielectric Characteristics for Radio Frequency Applications” in International Journal of Applied Ceramic Technology Vol. 7, No. 4 (2010) pp. 452-460, magnetodielectric polymer composites may be used as substrates for the miniaturization of radiofrequency devices such as antennas.

The work by Yang and colleagues “Comprehensive Study on the Impact of Dielectric and Magnetic Loss on Performance of a Novel Flexible Magnetic Composite Material”, Proceedings of the 38th European Microwave Conference, in Amsterdam, October 2008, is concerned with the application of magnetodielectric polymer composites in radiofrequency identification systems (RFID).

Lee and Cho et al., in the paper “Flexible Magnetic Polymer Composite Substrate with Ba_{1.5}Sr_{1.5}Z Hexaferrite Particles of VHF/Low UHF Patch Antennas for UAVs and Medical Implant Devices” in Materials 2020, 13, 1021 pp. 1-10 from 2020, reported on the miniaturization of antennas by means of integrated flexible polymer composites of polyurethane/hexaferrite which can be used in the frequency range from several hundred MHz, in particular at 400 MHz in drones or in medical implants.

Using magnetodielectric polymer composites, the relationships, for miniaturization in the context of stripline antennas with refractive index n and miniaturization factor k, are then as follows for the real components of the permittivity ε′ and of the magnetic permeability μ′:

$$\\ \begin{matrix}n = \sqrt{{ε}^{′} \cdot {μ}^{′}} and k = \frac{1}{\sqrt{{ε}^{′} \cdot {μ}^{′}}} & Eq . 1\end{matrix}$$

Stripline antennas with magnetodielectric polymer substrates, relative to purely dielectrically filled polymer composites, owing to μ>1, have a higher refractive index and according to Eq. 2 better impedance matching IM as well.

$$\\ \begin{matrix}IA = \sqrt{\frac{{μ}^{′}}{{ε}^{′}}} and ID = ( 1 - \sqrt{\frac{{μ}^{′}}{{ε}^{′}}} ) & Eq . 2\end{matrix}$$

For the ideal case of impedance matching IM=(μ′/ε′)^{1/2}=1 or of an impedance difference ID=0, reflections and surface waves of the stripline antenna disappear; such phenomena may themselves produce a certain power loss during operation of the antenna.

Appreciable magnetic and dielectric attenuation losses and hence losses in the power absorbed and output during reception and transmission by the antennas may arise in the MHz and GHz frequency range if the magnetodielectric polymer substrates are unfavourably chosen, especially in the case of strongly attenuating magnetic fillers and polymer matrices. For antennas with high radiation efficiency and relatively large antenna gain in the range of the resonant frequency fᵣ, extremely small dielectric and magnetic attenuation losses in the polymer composites used are required. The loss tangent values are calculated respectively from the quotients of the imaginary components μ″ and ε″ and the associated real components ε′ and μ′, with adequately small attenuation losses lying still below 0.1:

$$\\ \begin{matrix}tan {δ}_{ε} = \frac{{ε}^{″}}{{ε}^{′}} < 0 , 1 and tan {δ}_{μ} = \frac{{μ}^{″}}{{μ}^{′}} < 0 , 1 & Eq . 3\end{matrix}$$

In the production of the magnetodielectrically filled polymer composites, the aim is for a high degree of dispersion and a substantial individualization of the magnetic filler particles in a 0-3 environment with the polymer matrix. An overview of purely dielectrically and also magnetically filled polymer-ceramic composites with a 3-dimensional connectivity of the ceramic component to the polymer phase is provided by the work by Sebastian and Jantunen, “Polymer-Ceramic Composites of 0-3 Connectivity for Circuits in Electronics: A Review” in International Journal of Applied Ceramic Technology, Vol. 7, No. 4, (2010) pages 415-434.

Van der Waals forces are weak interactional forces between atoms and molecules that, in the paper by Winkler, “Dispergieren von Pigmenten und Füllstoffen, Farben und Lacke”, published by Vincentz, SBN-10: 3866309090, from November 2010, decrease with increasing distance, including between filler particles, by a power of 6.

In line with the studies in the dissertation by Damavandi at the Technical University of Kaiserslautern from 2015, “Effect of internal surfaces on the structural and mechanical properties of polymer-metal composites” in section 2.5.5 “Internal surface of the fillers”, the van der Waals forces and the propensity to form agglomerates increase massively with increasing packing density and especially when the particle sizes of the fillers are reduced from a few micrometres to particles having submicron or nanoscale dimensions.

Through the reduction in the degree of dispersion and through insufficient individualization of the magnetic filler component in the polymer substrates, permittivity ε′ and magnetic permeability μ′ are lowered, and this, in the radiofrequency range, is attended by a lowering of the refractive index of the polymer composites.

Using hyperbranched or dendritic polymer compounds is intended to disperse the magnetic filler particles in the polymer matrix and to incorporate them in an idealized 0-3 environment with the polymer component. The special spacer function of the hyperbranched polymers in the highly filled magnetodielectric polymer composites allows the permittivity ε′ and magnetic permeability μ′ to be raised and hence the refractive index of the polymer-based antenna substrates to be lifted.

Typical dispersion additives with chemical coupling effect suitable for the incorporation of fillers and pigments into plastics, according to “Applied Plastics Engineering Handbook”, edited by Myer Kutz, Elsevier Inc. 2017, ISBN: 978-0-323-39040-8, in Chapter 25 “Dispersants and Coupling”, include organosilanes, organometallic compounds (such as titanates, zirconates and aluminates), unsaturated carboxylic acids, acrylic and maleic acid-functionalized polymers, which because of the anchor-buffer structure may also contribute to the steric stabilization and better deagglomeration of the magnetic particles in the magnetodielectric polymer composites.

Owing to the polar nature of these dispersion adjuvants, however, the dielectric and magnetic attenuation losses of the filled polymer composites climb sharply.

Apolar or polar wax additives without specific coupling function such as polyolefin waxes, amide and montan waxes, depending on compatibility with the polymer matrix, act as external (incompatible) and internal lubricants (compatible), which may improve melt processability during processing and, in particular, may lower the viscosity.

The dispersive effect of the readily flowing wax additives is reduced in the case of the sintered ferrites by the porosity of the ceramic particles and by the greater absorption of the polymer melt at the open-pored ferrite surface.

Patent US 20150255196 for the University of South Florida, “Magneto-Dielectric Polymer Nanocomposites and Method of Making” from 2015, claims CoFe₂O₄ and Fe₃O₄ nanoparticles in a butadiene copolymer solution, and uses the interface-active substances oleylamine and oleic acid to stabilize the nanoparticles with respect in particular to oxidation. In the absence of spatial extent of a highly branched molecular structure of the hyperbranched polymers or dendrimers, however, the interface-active substances described are unable to develop adequate individualization and spacer effect between the magnetic particles in the polymer composites.

Patent KR20180060496 for LG Electronics Inc., “Magnetic and Dielectric Composite Structure and Method for Fabricating the same and Antenna for Using the same” from 2018, reports on the sheathing of soft-magnetic metal particles of Fe, Co, Ni, Mn and alloys thereof with a particle diameter of between 10 to 500 nm by means of electrically insulating oxides such as SiO₂, Al₂O₃, TiO₂ and ZrO₂ with a layer 1 to 30 nm thick, to be incorporated into polymer matrices such as polyvinylpyrrolidone, polydimethylsiloxane, PMMA, PET, cycloolefin copolymer, polystyrene and polyethylene naphthalate and employed as magnetodielectric substrates for antennas (e.g. PIFA) between 700 MHz to 3 GHz. But because the dielectric and magnetic attenuation values of the antenna substrates within the frequency range under investigation, at tan δ_{ε}˜0.25 and tan δ_{μ}˜0.9-1.0, are well above the upper limiting values of Eq. 3, radiation efficiency and gain are greatly reduced for these antenna systems.

Patent WO2019143502 for Rogers Corporation, “Core-Shell Particles, Magneto-Dielectric Materials, Methods of Making, and Uses thereof” from 2019, claims both the production and the use of magnetic particles in magnetodielectric polymer composites having a core-shell architecture (core-shell particles) for the frequency range around and above 1 GHz, with the shell of the Fe, Ni or Co particles being formed by methods including oxidation using chemical oxidizing agents such as oxygen or in a plasma and also from nitride in a separate process step. A disadvantage as well as this additional process step is the use of oxidizing agents, such as KMnO₄, K₂Cr₂O₇ and HNO₃, whose reaction products have to be removed from the operation and from the treated magnetic particles.

Nanoscale dispersion additives established for filled polymer composites have in recent years included polyhedral oligosilsesquioxanes (POSS compounds).

Specific properties and applications of these semi-organic framework silicates are described in Xanthos, “Functional Fillers for Plastics”, Chapter 23: Polyhedral Oligomeric Silsesquioxanes. WILEY-VCH, Weinheim, 2010 and by Blanco and colleagues in the study “POSS-Based Polymers” in Polymers 11, 1727 pp. 1-5 from 2019.

In line with the paper by Lee, Hwang et al., “Low Dielectric Materials for Micro-electronics in Dielectric Materials”, edited by Silaghi, Chapter: 3, pp. 59-76, in INTECH Open Access Publisher from January 2012, the dielectric constant and thus the refractive index of the polymer-POSS composites are lowered by means of nanocavities in the cage structures of the POSS compounds.

Insertion of these semi-organic framework silicates into the magnetodielectric polymer composites for more effective dispersing of the ferrite component thus runs counter to the intended increase in refractive index and miniaturization of the antenna substrates.

Patent WO2019006184 for Blueshift Materials Inc., “Hyperbranched POSS based Polymer Aerogels” from 2019, claims a hyperbranched polymer aerogel consisting of a polymer matrix with open-celled structure and of an organically modified POSS polymer.

Owing to the lowered density, this polymer material is used for radiofrequency applications and specifically as an antenna substrate with reduced permittivity. As the density reduction entails a drop in refractive index for the aerogels as well, these materials are unsuited to antenna miniaturization.

Gao and Yan in the study “Hyperbranched Polymers: from Synthesis to Applications” in Progress in Polymer Science, 29, (2004) pp. 183-275, set out the potential of hyperbranched/dendritic polymer compounds for improving the processability in plastics processing, and their suitability especially as dispersion additives for filled polymers.

Hyperbranched and dendritic polymers in the review article by Douloudi and colleagues, “Dendritic Polymers as promising Additives for the Manufacturing of Hybrid Organoceramic Nanocomposites with ameliorated Properties suitable for an extensive Diversity of Applications” in Nanomaterials 2021, 11, 19, pp. 1-36, are also used as additives for analysis (chromatography), in functional coatings in electronics and sensor technology, for chemical catalysis, and in medical applications (gene transfer, as antibacterial polymer composites and for administration of active ingredients).

Also mentioned in the context of magnetodielectric materials, in the patents WO2018119341 “Multi-Layer Magneto-Dielectric Materials” and WO2018140588 “Method of Making a Multi-Layer Magneto-Dielectric Material” for Rogers Corporation from 2018, as well as the use of polymer matrices from the large class of the thermoplastic and thermoset plastics, is the use of otherwise unspecified dendrimers, though they are employed only in the dielectric interlayers of the laminates and so are unable to act as spacers in a 0-3 structure between the magnetic filler particles of the ferromagnetic layer.

Patent US20090053512 for ABOR Universities of Arizona, “Multifunctional Polymer coated Magnetic Nanocomposite Material” from 2009, describes polymer-coated nanoparticles comprised of a metallic ferromagnetic core, in particular of cobalt, and of a polymer shell. These polymer-coated nanoparticles may also comprise a dendritic/hyperbranched polymer shell. The shell-clad particles can also be oriented into chain-like structures under the action of a magnetic field. In line with the observations in patent US20090053512 (paragraph 0155), the shell-clad cobalt nanoparticles can be used in a coating or in a substrate as microwave absorbers, though this rules out their use as low-attenuation, polymer-based antenna substrates.

Chinese Patent CN111548612 for Shenzhen Halcyon New Materials Co., Ltd. Company, “PCT/LCP Resin Composition for 5G Antenna Oscillator Base Materials as well as Preparation Method and Application thereof” from 2020, claims polymer blends of PCT (cyclohexanedimethanol-dimethyl terephthalate—CHDM-DMT) and TLCP (thermoplastic LCP) with a glass or wollastonite fibre or a mineral component as antenna substrates for the 5G frequency range.

Dispersion additives used in the PCT/TLCP polymer composites include, among others, hyperbranched polymers. But the PCT/TLCP polymer composites described are present only as purely dielectrically filled polymer formulas. Dielectric glass fibres or mineral components used, owing to the low permittivity of the fillers relative to customary titanates, niobates or zirconates, in line with the review study by Sebastian, Ubic and Jantunen, “Microwave Materials and Application”, ISBN 9871119208525, First Edition, John Wiley & Sons, pp. 855 ff. from 2017, make only a small contribution to raising the refractive index of the polymer composites, especially as the non-magnetic fillers only have a magnetic permeability μ′ of 1. The studies by Menezes and Fechine et al., “From Magneto-Dielectric Biocomposite Films to Microstrip Antenna Devices” in Journal of Composite Science, 2020, 4, 144, pp. 1-20, saw incorporation, into biopolymers of chitosan, cellulose and collagen, of superparamagnetic iron oxide nanoparticles (SPIONS). To improve the dispersing of the magnetic iron particles into the polymer matrices, and higher stability towards oxidation, the surface of the nanoparticles was functionalized with hyperbranched polyethyleneimine (bPEI). The aptitude of the resultant magnetodielectric biocomposites as polymer substrates was then investigated in patch antennas.

The influence of the complex permeability (μ*=μ′−iμ″) and of the magnetic attenuation loss tan δ_{μ} were in this case disregarded, as μ′ is set at 1 for the real component. In the frequency range between 0.4 to 4.5 GHz, however, for the biopolymer SPIONS investigated, appreciable dielectric attenuation losses were found, of between 0.15 to 0.4. Together with the uncaptured magnetic attenuation loss, the use of these high-attenuation polymer substrates in the patch antennas is likely to produce a sharp reduction in antenna gain and in radiation efficiency.

### SUMMARY OF ADVANTAGEOUS EMBODIMENTS OF THE INVENTION

The concept, used below, of hyperbranched spacer molecules pertains to organic molecular structures of polymer compounds which feature a random, 3-dimensional, spatial branching, with a multiplicity of functional groups and nanocavities, and which possess a pseudo-centre, so that when these molecules are used in the filled polymer composites, a space-occupying function (spacer effect) is also apparent.

In the invention which follows, the reaction product of the hyperbranched polyethyleneimine (PEI) after amidation with palmitic acid C₁₅H₃₁COOH is designated PEI-C16 and with stearic acid C₁₇H₃₅COOH is designated PEI-C18, with the abbreviation PEIA being introduced as a generic term.

Improving the miniaturization of antennas, of the patch, dipole and planar inverted F-antenna (PIFA) types, for example, for the MHz and bordering GHz frequency region is an object of the invention.

The object is achieved through the incorporation and presence of hyperbranched spacer molecules. These molecules raise the refractive index of the polymer substrates used, within a particular filler range or at constant filler fraction of the magnetic component, with an accompanying boost to permittivity ε′ and magnetic permeability μ′.

Polymer substrates used for the miniaturization of the antennas, with the hyper-branched polymer compound, take the form of magnetodielectric polymer composites with a magnetic filler, or of polymer hybrids with two or more magnetic filler components.

These magnetodielectric polymer substrates feature low dielectric and magnetic attenuation losses, so fulfilling tan δ_{ε}=ε″/ε′<0.1 and tan δ_{μ}=μ″/μ′<0.1.

The magnetodielectric polymer substrates, through the addition of the hyperbranched spacer molecules, by μ′>1 relative to purely dielectrically filled polymer composites with μ′=1, achieve improved impedance matching IM, so resulting also in lower losses by the antenna because of surface waves and reflections.

### BRIEF DESCRIPTION OF THE FIGURES

FIG. 1 illustrates the modification of hyperbranched PEI with fatty acids of the general formula R—COOH to form PEIA;

FIG. 2 schematically illustrates a PEIA-sheathed magnetic particle;

FIG. 3 is a graphical comparison of permittivity ε′, magnetic permeability μ′ and the refractive index for various COC-hexaferrite composites at 400 MHz and 800 MHz;

FIG. 4 is a graphical comparison of permittivity ε′, magnetic permeability μ′ and the refractive index for various ABS-spinel ferrite composites at 400 and 800 MHz;

FIG. 5 graphically contrasts dielectric and magnetic attenuation losses for various ABS-spinel ferrite composites at an exemplary frequency of 800 MHz;

FIG. 6 graphically illustrates the increase in permittivity ε′, magnetic permeability μ′ and the refractive index for hybrids of various ABS-hexaferrites using a PEIA spacer compound at 400 and 800 MHz;

FIG. 7 schematically illustrates the experimental set-up for determining a shift of resonant frequency;

FIG. 8 graphically illustrates the shift of resonant frequency of a dipole antenna in different magnetodielectric environments as a function of frequency and refractive index;

FIG. 9 graphically illustrates a resonant frequency shift of an antenna before sheathing and after application of the inventive polymer substrate (901); and

FIG. 10 are photos of an exemplary antenna structure before sheathing and after application of an exemplary inventive magnetodielectric polymer composite.

### DETAILED DESCRIPTION OF ADVANTAGEOUS EMBODIMENTS OF THE INVENTION

The object of the invention is achieved by using magnetodielectric polymer substrates with a filling of magnetic particles surrounded by amphiphilic hyperbranched spacer molecules. The amphiphilic nature of the spacer molecules causes them to attach by their polar side to the high-energy surface of the magnetic particles, whereas the apolar regions of the spacer compound molecules are able to spread out in the apolar, low-energy polymer matrix. As a result, the magnetic particles are sheathed in micelle manner with the hyperbranched spacer molecules and incorporated in a 0-3 connectivity to the matrix.

The improved dispersing and individualization of the magnetic particles cause permittivity ε′ and magnetic permeability μ′ and hence the refractive index of the magnetodielectric polymer composite to increase, whereas the dielectric and magnetic attenuation losses are lowered to values of tan δ_{ε}<0.1 and tan δ_{μ}<0.1.

The magnetic particles used possess soft-magnetic properties, like a low coercitivity H_{c}<1000 A/m and a low remanence (residual magnetization), resulting in values of μ′>1 or μ′>>1 for the real component of the magnetic permeability.

The soft-magnetic particles are ceramics or alloys containing the elements cobalt, iron, manganese or nickel. Particularly suitable for use in polymer substrates for the miniaturization of antennas in the MHz and bordering GHz frequency range are Z-type barium cobalt hexaferrite (Ba₃Co₂Fe₂₄O₄₁), nickel zinc ferrite of the general formula NiₐZn₍₁₋ₐ₎Fe₂O₄ or magnetite (Fe₃O₄) or else combinations of these substances. The mean particle size d₅₀ of the particles with soft-magnetic properties is in the range from 0.05 to 10.0 μm.

The spacer molecules used are hyperbranched polyethyleneimines which have been additionally functionalized with apolar groups. This results in amphiphilic substances able both to interact with the polar surface of the magnetic particles and to spread out in the apolar matrix. The magnetic particles are sheathed in micelle manner with the hyperbranched spacer molecules and so are individualized more effectively and dispersed more evenly in the matrix.

The hyperbranched spacer molecules are functionalized preferably with fatty acids, more preferably palmitic acid and stearic acid.

The polymer matrix is the main component of the magnetodielectric polymer substrate in the antenna construction. The matrix is responsible for the strength and structure or else the flexibility of the plastic used.

The matrix material consists of an apolar, low-energy polymer having low dielectric attenuation tan δ_{ε}<0.02, more particularly tan δ_{ε}<0.01, as for example of polyolefins such as cyclic olefin polymer (COP), cyclic olefin copolymer (COC), polyethylene (PE) and polypropylene (PP), styrene-containing polymers, such as polystyrene (PS), impact-modified polystyrene (HIPS) and acrylonitrile-butadiene-styrene copolymer (ABS), polyoxymethylene (POM), polyesters such as polyethylene terephthalate (PET), polybutylene terephthalate (PBT) and polyethylene naphthalate (PEN), polycarbonate (PC), polyphenylene ether (PPO), polyphenylene sulfide (PPS), fluorine-containing polymers such as polytetrafluoroethylene (PTFE), polyvinylidene fluoride (PVDF), perfluoro(ethylene-propylene) (FEP) and ethylene-tetrafluoroethylene copolymers (ETFE), thermoplastic elastomers (TPE) such as polyether-block-amides (PEBA), 1-component solid-silicone elastomers such as room temperature-crosslinking (RTV) or high temperature-crosslinking (HTV) silicone rubbers, liquid 2-component silicone rubbers (liquid silicone rubber, LSR) such as polydimethylsiloxane, or of ethylene-propylene-diene rubber (EPDM, ethylene-propylene-diene; M group), epoxy resin casting compounds (cold- or hot-curing) or of acrylate ester-containing epoxy resins.

The polymer composite of the invention is produced by compounding via extrusion or by kneading of the thermoplastic matrix polymer, or from liquid particle dispersions of the dissolved polymer with admixture of the amphiphilic hyperbranched spacer molecules and of the magnetic particles. The magnetodielectric polymer composite is obtained from the liquid magnetic-particle dispersions of the dissolved polymer in a further process step, after removal of the solvent. The terms “polymer substrate” and “polymer composite” are synonymous and interchangeable in the context of the present invention.

The magnetically filled polymer composites are pelletized and processed on an injection moulding machine to give plate-like intermediates as a polymer substrate for an antenna or to give housings for accommodating an antenna construction.

Filaments produced from the pellets of the magnetodielectric polymer composites can be processed to give specific intermediates using the additive manufacturing method of fused filament fabrication (FFF).

From the filaments, housings for accommodating an antenna are printed, or the antenna construction is sheathed directly with the magnetodielectric polymer composite via the FFF process.

For the production of the magnetically filled polymer composite from 1-component solid silicone elastomer or EPDM, the rubber is admixed with amphiphilic hyperbranched spacer molecules and magnetic particles in the kneader and the mixture is subsequently processed on a roll mill. The magnetically filled rubber mixture is pressed to give plate-like intermediates which can be used as a polymer substrate for antenna miniaturization.

Magnetic particles and amphiphilic hyperbranched spacer molecules are incorporated by dispersion into liquid 2-component silicone elastomers or else epoxy resin mixtures by a combined treatment of high-speed homogenization and ultrasound.

The liquid matrix/magnetic-particle dispersions can be cast in cavities and cured to give plate-like intermediates, which are subsequently employed as polymer substrates in antenna construction. Liquid matrix/magnetic-particle dispersions can also be used via casting to ensheath an antenna, then allowing the antenna construction to be miniaturized.

Pellets of the magnetodielectric polymer composites and hybrids can be obtained on a twin-screw extruder by compounding of polymers with ferritic fillers, after drawing off the melt as a strand through a water bath and performing strand pelletization. The pellets are then moulded to give plate-like intermediates on an injection moulding machine.

The production of the amidated polyethyleneimine (PEIA) is known to those skilled in the art, such as PEI-C16 and PEI-C18 is described in the work by Gladitz, “Untersuchungen zur Herstellung, Charakterisierung und Applikation von antimikrobiellen Metall-Hybriden für Beschichtungen und Compounds”, a dissertation at Martin Luther University, Halle-Wittenberg, dated 12 Mar. 2015.

The PEIA component is metered into the polymer melts during compounding in the extruder. PEIA has also been incorporated, in an acetonic polymer solution together with the magnetic ferrite particles, into the polymer/ferrite dispersions by shearing and then dried under reduced pressure.

After the organic solvent has been evaporated off and the film-like residue pelletized, the magnetically filled polymer material can be injection moulded into plate-like intermediates.

Another polymer composite with a ferrite filler and amidated polyesterimine can be processed on a catheter extrusion line to give a filament 1.75 mm in thickness and then printed to give plate-like intermediates and also used to sheath a dipole antenna by means of fused filament fabrication (FFF).

Polymer adjuvants consisting of polyhedral oligosilsesquioxanes octamethyl-POSS (OMP) and trisilanolisobutyl-POSS (TSP) and of the amphiphilic copolymer TEGOMER® P121 for dispersions of polymer-filler concentrates based on a hard wax are compared as reference additives with the amidated polyethyleneimine (PEIA) in the magnetodielectric polymer-ferrite composites. Permittivity ε′ and magnetic permeability μ′ and thus the refractive index n of the polymer composites can only be raised when using the amphiphilically modified and hyperbranched PEIA with sufficiently small attenuation losses tan δ_{ε}<0.1 and tan δ_{μ}<0.1.

### Preferred Forms of Use

Magnetodielectric polymer composites and hybrids can be used, subject to the proviso of low dielectric and magnetic attenuation losses tan δ_{ε}=ε″/ε′<0.1 and tan δ_{μ}=μ″/μ′<0.1, as substrate materials for the miniaturization of antennas in the MHz and bordering GHz range.

The amphiphilic hyperbranched polymer PEIA acts as a dispersing assistant when the magnetodielectric composites are processed via extrusion or on incorporation into liquid polymer-ferrite particle dispersions, and unlike the contemplated reference additives OMP, TSP and P121 also act as an effective spacer molecule between the magnetic filler particles in the polymer composite.

As both the permittivity ε′ and the magnetic permeability μ′ of the magnetodielectric polymer composites and hybrids increase with the PEIA component, the refractive index is raised appreciably, and this can be utilized, for example, for additional miniaturization of the antenna structures or else for saving on the magnetic filler while at the same time lowering the attenuation losses.

Utilized as possible working frequencies for the present magnetodielectric polymer composites with the spacer compound PEIA in a miniaturized antenna are the specific ranges of 400 MHz for emergency frequencies and 800 MHz for the mobile communications standard LTE (Long Term Evolution)/4G or the lower 5G range from 700 bis 900 MHz, although a larger frequency range from 50 MHz to 4 GHz is favoured for the polymer substrates.

### DETAILED DESCRIPTION OF FIGURES

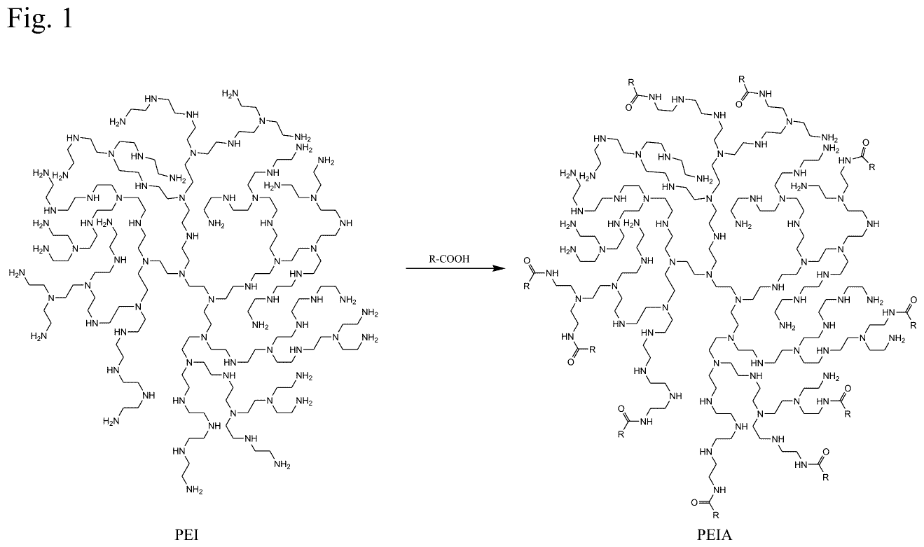

FIG. 1 shows the hyperbranched PEI and the modification with fatty acids of the general formula R—COOH, giving an amphiphilic hyperbranched PEI (PEIA).

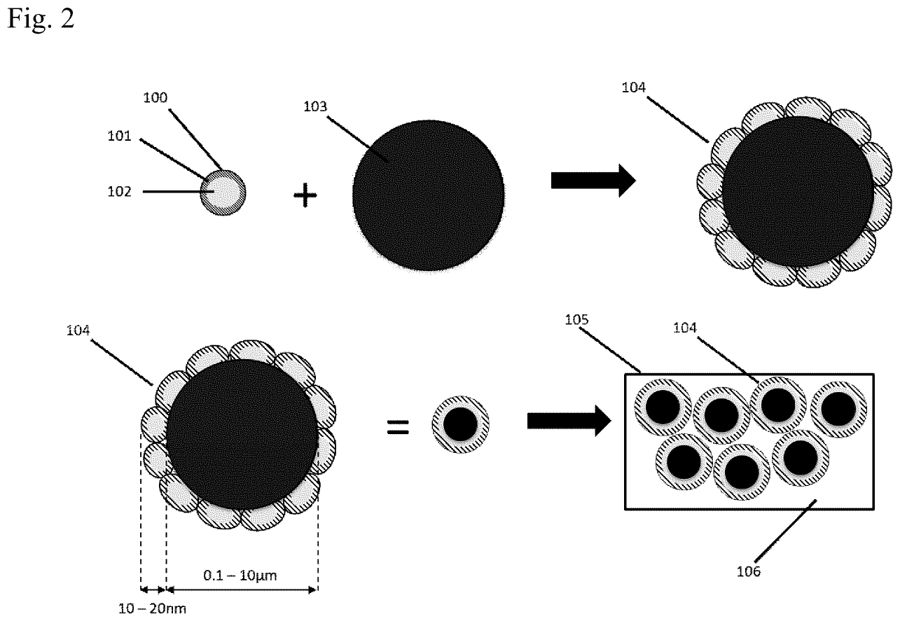

FIG. 2 shows schematically the interaction of PEIA (100), consisting of an apolar region (101) and a polar region (102), with the magnetic particle (103), to give a PEIA-sheathed magnetic particle (104). In a polymer composite (105) of PEIA-sheathed magnetic particle (104) and matrix polymer (106), the sheathing results in individualization of the magnetic particles.

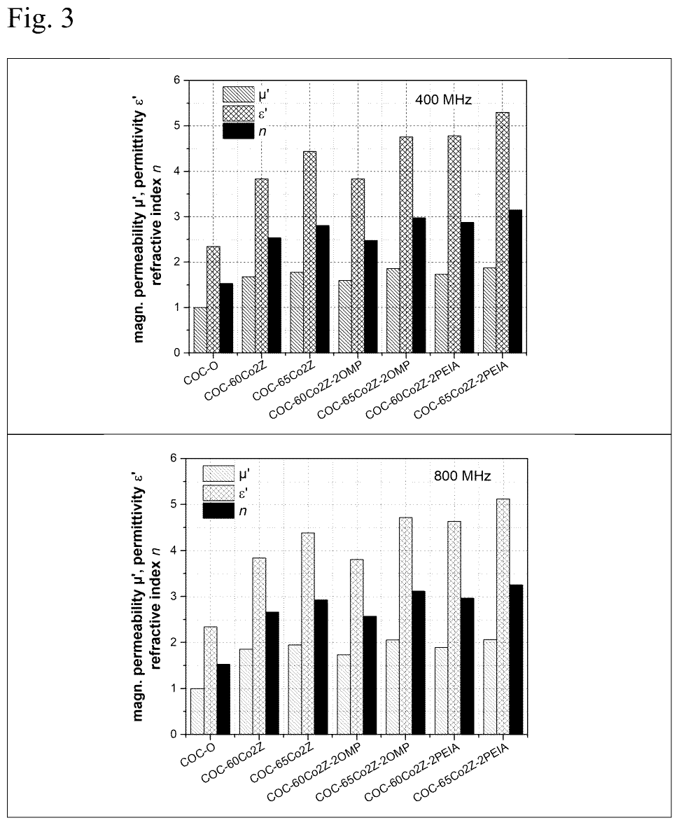

FIG. 3 compares permittivity ε′, magnetic permeability μ′ and the refractive index for COC-hexaferrite composites without additional additive, with OMP and with the PEIA spacer compound, using for example the practically relevant frequencies of 400 and 800 MHz.

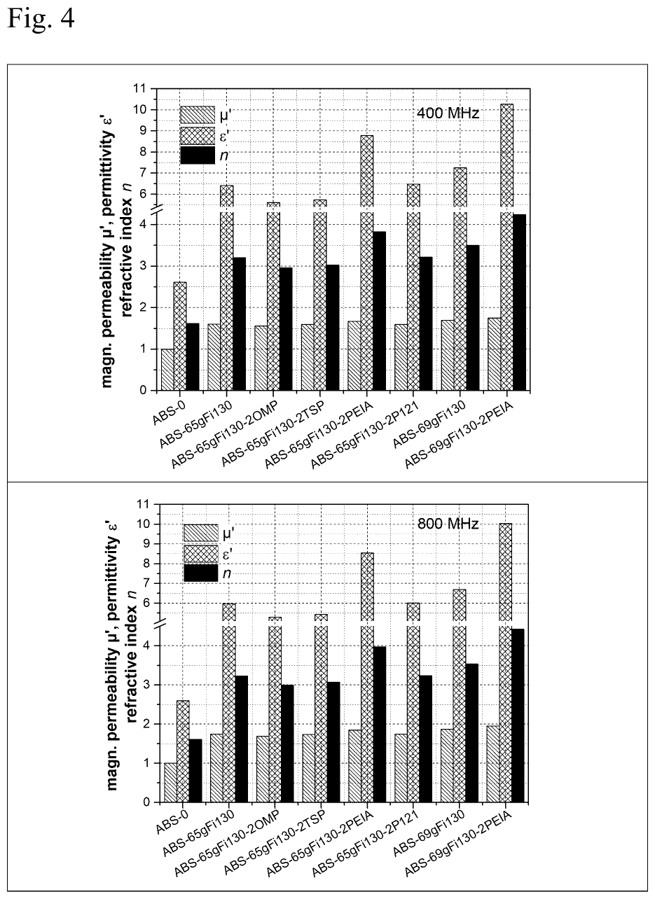

FIG. 4 compares permittivity ε′, magnetic permeability μ′ and the refractive index for ABS-spinel ferrite composites without additional additive, with the POSS additives OMP and TSP and with the PEIA compound, at 400 and 800 MHz.

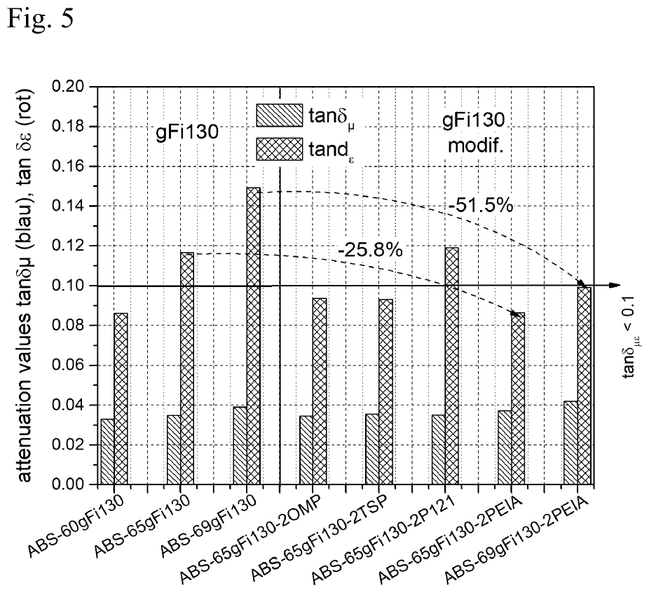

FIG. 5 contrasts dielectric and magnetic attenuation losses for ABS-spinel ferrite composites without additional additive, with the POSS additives OMP and TSP and with the PEIA compound, using for example the frequency of 800 MHz.

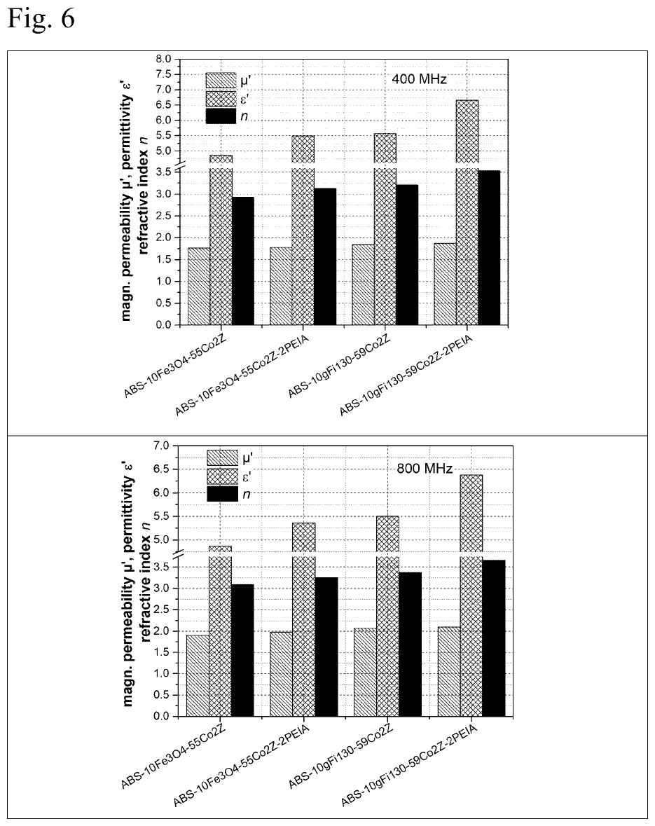

FIG. 6 shows the increase in permittivity ε′, magnetic permeability μ′ and the refractive index for hybrids of ABS-magnetite hexaferrite and ABS-spinel hexaferrite when using the PEIA spacer compound at 400 and 800 MHz.

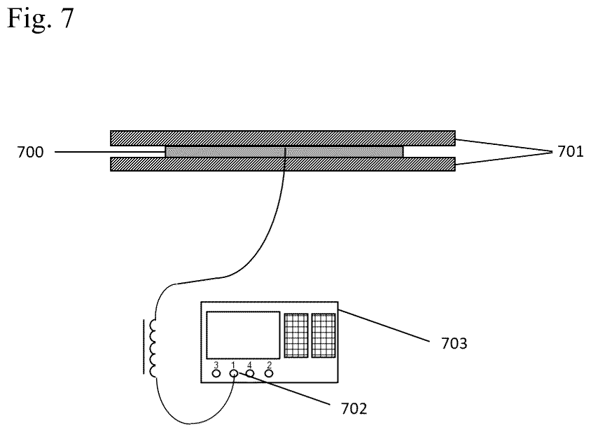

FIG. 7 shows the experimental set-up for determining the shift of resonant frequency by the surrounding magnetodielectric material on a flat antenna dipole.

The flat antenna dipole (700) is embedded on two sides by the magnetodielectric substrate layer (701). The S11 scattering parameter is measured via Port1 (702) of the network analyser (703).

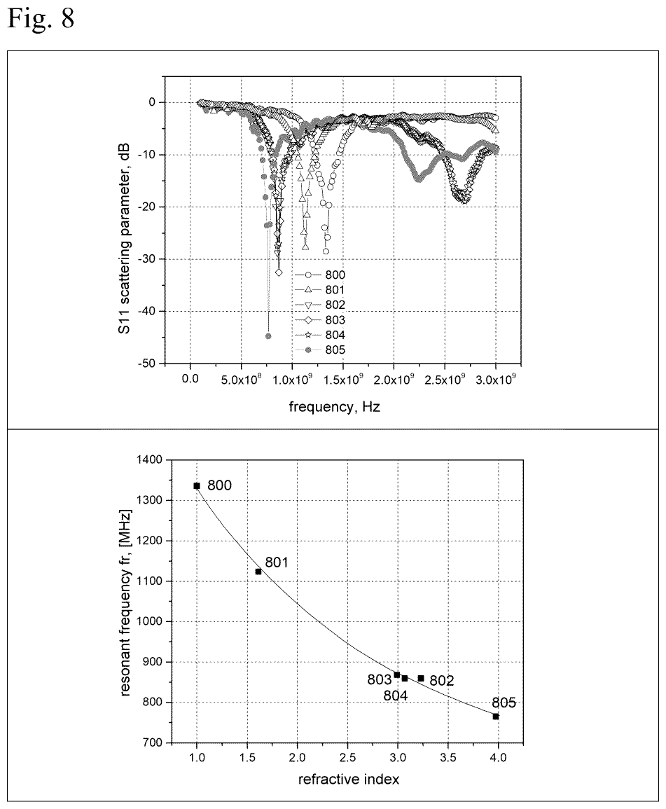

FIG. 8 shows the shift of resonant frequency of a dipole antenna 9.4 cm long in different magnetodielectric environments as a function of frequency and refractive index.
(800) antenna in air environment
(801) antenna with ABS
(802) antenna with ABS-65gFi130 composite
(803) antenna with ABS-65gFi130-20MP composite
(804) antenna with ABS-65gFi130-2TSP composite
(805) antenna with ABS-65gFi130-2PEIA composite

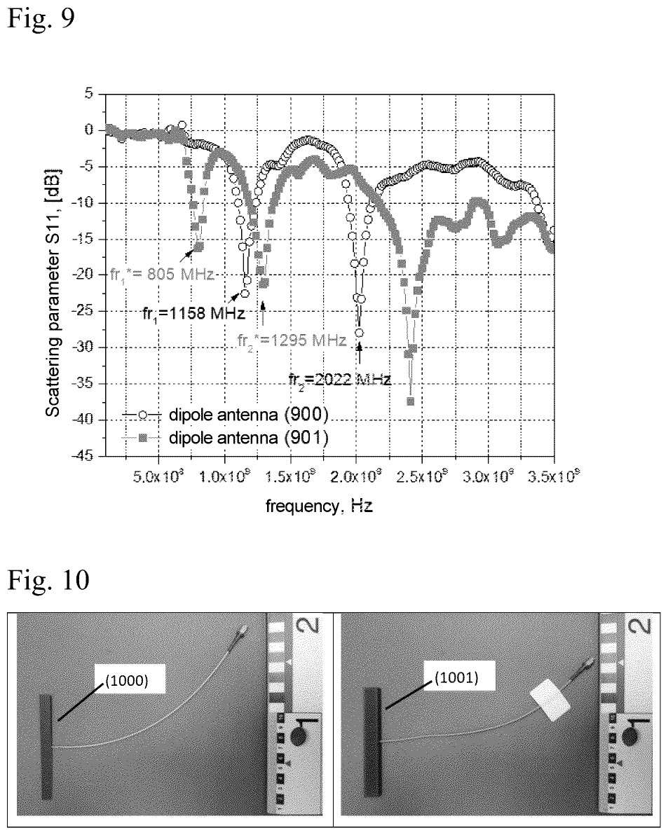

FIG. 9 represents the resonant frequency shift of an antenna structure with two dipoles after sheathing via 3D printing process with the magnetodielectric polymer composite UBE-65gFi130-2PEIA and the amphiphilically modified polyester-imine component, before sheathing in the air dielectric (900) and after application of the polymer substrate (901).

FIG. 10 shows photos of the antenna structure before sheathing (1000) and after application of the magnetodielectric polymer composite UBE-65gFi130-2PEIA (1001).

### EXAMPLES

### Methods

An Agilent E4991A impedance analyser was used for determining the complex magnetic permeability μ* (μ′, μ″ and tan δ_{μ}) and the complex permittivity ε* (ε′, ε″ and tan δ_{ε}) via measuring sockets 16454A and 16453A in the frequency range between 10 MHz to 1 GHz. The complex magnetic permeability μ* was measured dependent on frequency on perforated discs 2 mm thick with an outer diameter of 19 mm and an inner diameter of 6 mm, and the complex permittivity ε* on coupons 2 mm thick with a diameter of 19 mm, extracted from the magnetodielectric polymer composites and hybrids by milling.

### Chemicals

APEL™ APL5014DP is a cyclic olefin copolymer from Mitsu Chemicals America, Inc., with an MFI of 36 g/10 min 260° C./2.16 kg, measured to ASTM D1238.

ELIX ABS 3D GP is an acrylonitrile-butadiene-styrene copolymer from ELIX Polymers, Tarragona, with an MVR of 18 cm³/10 min 220° C./10 kg, determined to ISO 1133.

UBE68 UBESTA® XPA 9068X1 is a polyamide 12 elastomer from UBE Industries, Ltd. Japan, with an MFR of 4 g/10 min 190° C./2.16 kg, determined to ISO 1133-2.

CO₂Z is a Z-type Ba₃Co₂Fe₂₄O₄₁ hexaferrite with d₅₀˜5.1 μm from Trans-Tech.

gFi130 is a ferrocarite-type NiZn ferrite from Sumida AG with a d₅₀˜0.7 μm after grinding.

Fe₃O₄ is an E8707H magnetite from Lanxess with a dₘₑₐₙ˜0.2 μm.

Octamethyl-polyoligosilsesquioxanes (octamethyl-POSS, OMP) and trisilanolisobutyl-polyoligosilsesquioxanes (trisilanol-isobutyl-POSS, TSP) were obtained from Hybrid Plastics, Hattiesburg.

The dispersion additive TEGOMER® P121 is an amphiphilic copolymer from Evonik Nutrition & Care GmbH.

PEIA is an amidated polyethyleneimine. The preparation is described in the work by Gladitz “Untersuchungen zur Herstellung, Charakterisierung und Applikation von antimikrobiellen Metall-Hybriden für Beschichtungen und Compounds”, a dissertation at Martin Luther University, Halle-Wittenberg, dated 12 Mar. 2015.

Polymers used, magnetic fillers and special additives and the detailed processing conditions for the magnetodielectric polymer composites are given in Table 1.

TABLE 1
Polymers used for producing the magnetodielectric polymer composites,
magnetic fillers, special adjuvants and processing conditions

| Abbreviated | Polymer | Magnetic fillers | Special | |
|---|---|---|---|---|
| designation | matrix | and fill levels | adjuvants (2%) | Processing |
| COC | APEL ™ | Co₂Z: 60 and | OMP, PEIA | Extrusion: 240-260° C. |
| | APL5014DP | 65% | | Injection moulding: |
| | | | | 230-240° C. |
| ABS | ELIX ABS | gFi130: 65 | OMP, TSP, | Extrusion: 215-240° C. |
| | 3D GP | and 69% | P121, PEIA | Injection moulding: |
| | | Co₂Z/Fe₃O₄: | | 215-240° C. |
| | | 55%/10% | | |
| | | Co₂Z/gFi130: | | |
| | | 59%/10% | | |
| ABS | ELIX ABS | gFi130: 65% | PEIA | Acetonic ABS-ferrite |
| | 3D GP | | | dispersions: |
| | | | | Predispersing with |
| | | | | ULTRATURRAX ® |
| | | | | (15 min) and combined |
| | | | | with ULTRATURRAX ® |
| | | | | and in an ultrasonic bath |
| | | | | (30 min). |
| | | | | Injection moulding: 240° C. |
| UBE68 | UBESTA ® | gFi130: 65% | PEIA | Extrusion: 200-220° C. |
| | XPA nat. | | | Filament production: D = |
| | 9068X1 | | | 1.75 mm, 200-210° C., |
| | | | | 3D printing (fused filament |
| | | | | fabrication): 210° C. |

In the examples given, the polyethyleneimine LUPASOL® WF from BASF with an average molecular weight of 25 000, a water content of not more than 1% and a viscosity (50° C.) of 13 000-18 000 mPa·s was used and was then amidated with palmitic acid from Roth with a melting point of 62.5° C. and a molecular weight of 256.4 g/mol.

### Example 1

Incorporated into cyclic olefin copolymer APEL™ APL5014DP via extrusion were 60 and 65 mass % of the Co₂Z hexaferrite (Ba₃Co₂Fe₂₄O₄₁) and in each case 2% of pulverulent PEIA.

For two formulations with 60 and 65 mass % of the CO₂Z hexaferrite, for comparison no PEIA and for two further corresponding formulas 2% of the POSS compound OMP were introduced into the COC matrix by extrusion.

The increase in permittivity ε′ and in magnetic permeability μ′ and the consequent higher refractive index of the magnetodielectric polymer composites with the amidated polyethyleneimine (PEIA) relative to the comparative formulations without PEIA and with the POSS compound OMP are verified as per FIG. 3 both at 400 MHz and at 800 MHz.

### Example 2

Incorporated into the polymer ELIX ABS 3D GP via extrusive processing were 65 and 69 mass % of the finely ground spinel ferrite gFi130 (NiZn—Fe₂O₄) and in each case 2% of pulverulent PEIA.

For two formulations with 65 and 69 mass % of the spinel ferrite gFi130, for comparison no PEIA and for two formulas with 65 mass % of gFi130, in each case 2% of the POSS compounds OMP and TSP and for a further reference formulation 2% of the dispersion additive TEGOMER® P121 were incorporated.

A greater increase in permittivity ε′ and in magnetic permeability μ′ and the consequent higher refractive index of the magnetodielectric polymer composites when using the amidated polyethyleneimine (PEIA) relative to the trial formulations without PEIA and with the POSS compounds OMP and TSP are visible in FIG. 4 at 400 MHz and at 800 MHz as well.

### Example 3

To compare the dielectric and magnetic attenuation losses, 60, 65 and 69 mass % of the finely ground spinel ferrite gFi130 (NiZn—Fe₂O₄) without PEIA were incorporated into the polymer ELIX ABS 3D GP.

In further formulations with 65 mass % of the spinel ferrite gFi130, 2 mass % of the POSS compounds OMP and TSP and, in a formula with 65 mass % of gFi130, 2% of the dispersion additive TEGOMER® P121 were incorporated as reference formulations via extrusion.

The dielectric and magnetic attenuation losses of these reference samples were then compared with corresponding loss tangent values of extruded ABS-ferrite composites at 65 and 69 mass % fill level of the spinel ferrite gFi130 with in each case 2 mass % of the PEIA component.

The more effective dispersing and better spacer effect of the amidated polyethyleneimine cause reduction in particular in the dielectric attenuation losses of the ABS-65gFi130-2PEIA and ABS-69gFi130-2PEIA formulations relative to the formulas without PEIA, by 25.8 and 51.5%, respectively.

In line with FIG. 5, when using the PEIA, relative to the ABS-ferrite composites with the POSS compounds OMP and TSP and also when using the dispersion additive TEGOMER® P121, lower dielectric attenuation losses were consistently achieved. In the case of the ABS-gFi130 composites with 65 and 69 mass % of ferrite and 2 mass % of PEIA, both at 400 and at 800 MHz, the dielectric and magnetic attenuation losses achieve tan δ_{ε}=ε″/ε′<0.1 and tan δ_{μ}=μ″/μ′<0.1.

### Example 4

PEIA was introduced into liquid acetonic ABS-ferrite particle dispersions, which were strongly sheared through combined treatment via ULTRATURRAX® and ultrasound in line with Table 1. After removal of the acetone under reduced pressure and comminution of the film-like residue of the ABS-ferrite composite, plate-like intermediates were produced by injection molding.

Table 2 compares permittivity ε′ and magnetic permeability μ′ and attenuation losses tan δ_{ε} and tan δ_{μ} between filled ABS-gFi130 composites at 800 MHz, obtained via melt compounding and through the process of dispersion of ferrite in acetonic ABS solution. ABS-ferrite composites from the dispersion process feature significantly lower values in the real components of permittivity ε′ and magnetic permeability μ′ than the ABS-ferrite formulations from conventional melt compounding.

The lowering of ε′ and μ′ correlate with the reduction in the density of the ABS-ferrite composites produced by the dispersion process.

The reduction in permittivity ε′ and in magnetic permeability μ′ for these ABS-ferrite composites is caused by cavities formed by evaporating solvent remnants of the acetone during the injection moulding of the composites.

When the PEIA component is inserted into the acetonic ABS-ferrite dispersions, though, there are simultaneous increases in permittivity ε′, magnetic permeability μ′ and refractive index n relative to the composites without PEIA.

Of particular interest is the reduction in the dielectric and magnetic attenuation losses through the installation of micropores into the highly filled ABS-ferrite composite structure. In the presence of the PEIA spacer compound, the loss tangent values are additionally lowered again.

TABLE 2
Permittivity, magnetic permeability and loss tangent,
refractive index n and density ρ of the polymer
composites as a function of the production method at 800 MHz

| | | | | |
|---|---|---|---|---|
| | | | | n |
| μ′ | tanδ_{μ} | ε′ | tanδ_{ε} | ρ |

Production by melt compounding

| | | | | | |
|---|---|---|---|---|---|
| ABS-65gFi130 | 1.748 | 0.0347 | 5.972 | 0.1168 | 3.231 |
| | | | | | 2.136 |
| ABS-65gFi130-2PEIA | 1.848 | 0.0373 | 8.553 | 0.0867 | 3.976 |
| | | | | | 2.143 |

Production from liquid ABS-ferrite particle dispersion

| | | | | | |
|---|---|---|---|---|---|
| ABS-65gFi130, disp. | 1.607 | 0.0259 | 5.805 | 0.072 | 3.054 |
| | | | | | 2.025 |
| ABS-65gFi130-2PEIA, disp. | 1.617 | 0.0258 | 5.92 | 0.0647 | 3.094 |
| | | | | | 2.057 |

### Example 5

To improve particle distribution and the quality of mixing of the magnetic particles in the polymer composite, a second magnetic component was used in order to increase the refractive index, the permittivity ε′ and/or magnetic permeability μ′ of the magnetodielectric polymer system. For the fill levels c₁ of the primary magnetic component relative to the secondary component c₂, c₁>c₂.

The size difference in the mean diameter d₁ of the primary magnetic filler relative to the mean diameter of the secondary component d₂ here is intended to fulfil the condition d₁>>d₂ or d₁>d₂.

Subsequently, permittivity ε′ and magnetic permeability μ′ and also the refractive index n of the ternary magnetic-filled polymer hybrids without and after addition of PEIA spacer compound at 400 and 800 MHz were compared with one another.

Permittivity ε′ and magnetic permeability μ′ of the hybrids ABS-10Fe₃O₄-55Co₂Z and ABS-10gFi130-59Co₂Z in FIG. 6 increase significantly as a result of addition of PEIA, and this in line with Eq. 1 raises the refractive index and so reduces the miniaturization factor for an antenna having the magnetodielectric substrate.

For the dielectric and magnetic attenuation losses of the hybrids having the PEIA component, both at 400 and at 800 MHz, tan δ_{ε}=ε″/ε′<0.1 and tan δ_{μ}=μ″/μ′<0.1.

### Example 6

Arranged symmetrically around a dipole antenna 9.4 cm in length with a resonant frequency of 1335 MHz in air for the measurement of S11 scattering parameters (attenuation of return flow) on the ZVB14 network analyser were respective layers 2 mm thick of injection-moulded plates of pure ABS, of ABS-65gFi130 without additive, of ABS-65gFi130-20MP and of ABS-65gFi130-2TSP with two different POSS compounds and also of ABS-65gFi130-2PEIA with the PEIA spacer additive. The experimental set-up used is represented in FIG. 7.

The shift in the resonant frequency fᵣ of the dipole antenna is represented for the selected polymer substrate in FIG. 8 as a function of frequency and refractive index.

The dipole antenna with the sample ABS-65gFi130-2PEIA (805) with the PEIA component, both relative to the air environment (800) and in comparison to the samples ABS (801), ABS-65gFi130 (802) without additive, ABS-65gFi130-20MP (803) and ABS-65gFi130-2TSP (804) with the POSS compounds, exhibits the greatest shift in resonant frequency.

The shift in the resonant frequency into the low-frequency range of the dipole antenna correlates with the refractive index of the polymer composites under study, and so the use of the sample ABS-65gFi130-2PEIA (805) as antenna substrate with the highest refractive index in line with Eq. 1 results in the smallest miniaturization factor.

### Example 7

An antenna structure with two dipoles 10.7 and 5.5 mm in length and having resonant frequencies of 1158 and 2022 MHz in air was sheathed with a polyamide elastomer composite consisting of the matrix UBE68, ferrite filler gFi130 and PEIA additive using the 3D printing process of fused filament fabrication (FFF). For the 3D printing, a filament 1.75 mm in diameter was manufactured from the magnetodielectric polymer composite UBE68-65gFi130-2PEIA with 65 mass % of spinel ferrite and 2 mass % of PEIA. The thickness of the printed layer material on the antenna structure was 3 mm per side.

From FIG. 9 it is apparent that printing of the polymer composite UBE68-65gFi130-2PEIA around the antenna structure on both sides shifts the original resonant frequencies at 1158 and 2022 MHz (900) into a region of 805 and 1295 MHz (901), corresponding to a reduction in build size with fᵣ₁*/fᵣ₁=805/1158˜0.69 and fᵣ₂*/fᵣ₂=1295/2022˜0.64 of 31% and 36%.

That which is claimed:

1. A magnetodielectric polymer composite with a matrix comprised of one or more apolar polymers accommodating dispersed particles having soft-magnetic properties and a mean particle size d₅₀ of 0.05 to 10 μm,
wherein the particles having soft-magnetic properties are surrounded by amphiphilic hyperbranched spacer molecules, with the magnetodielectric polymer composite having a dielectric attenuation loss tan δ_{ε} of less than 0.1, a magnetic attenuation loss tan δ_{μ} of less than 0.1 and a refractive index n increased by comparison with a magnetodielectric polymer composite without amphiphilic hyperbranched spacer molecules, the refractive index n being defined as:
n=\sqrt{ε′·μ′} Eq. 1
where ε′ is the permittivity and μ′ is the magnetic permeability of the magnetodielectric polymer composite.

2. The magnetodielectric polymer composite according to claim 1, wherein the particles having soft-magnetic properties comprise ceramic or metal oxide compounds containing the elements cobalt, iron, manganese and/or nickel.

3. The magnetodielectric polymer composite according to claim 2, wherein the particles having soft-magnetic properties comprise are particles of Z type cobalt hexaferrite having a formula Ba₃Co₂Fe₂₄O₄₁, nickel zinc ferrite having a general formula NiₐZn₍₁₋ₐ₎Fe₂O₄ and/or magnetite (Fe₃O₄).

4. The magnetodielectric polymer composite according to claim 1, wherein the particles having soft-magnetic properties are microscale/submicron spinel ferrites that are NiZn ferrites having a mean particle size d₅₀ of 0.1 to 10.0 μm or microscale/submicron hexaferrites that are CO₂Z type having a formula Ba₃Co₂Fe₂₄O₄₁ and a mean particle size d₅₀ of 0.1 to 10.0 μm or a submicron/nanoscale magnetite having a formula Fe₃O₄ and a mean particle size d₅₀ of 0.05 to 10.0 μm.

5. The magnetodielectric polymer composite according to claim 1, wherein the particles having soft-magnetic properties include a mixture with differing composition and differing mean particle size d₅₀, the mean particle size d₅₀ of the particles each of the same composition differing by at least 1 μm from those of different composition.

6. The magnetodielectric polymer composite according to claim 5, wherein the mean particle size d₅₀ of the particles each of the same composition differ by at least 2 μm from those of different composition.

7. The magnetodielectric polymer composite according to claim 5, wherein the mean particle size d₅₀ of the particles each of the same composition differ by at least 3 μm from those of different composition.

8. The magnetodielectric polymer composite according to claim 1, wherein the amphiphilic hyperbranched spacer molecules are functionalized polyethyleneimines with apolar acyl groups which form an amide bond with primary amino groups of the polyethyleneimine.

9. The magnetodielectric polymer composite according to claim 8, wherein the acyl group has a formula —CO—CₙH₂ₙ₊₁ with n≥6.

10. The magnetodielectric polymer composite according to claim 8, wherein the acyl groups are hexadecanoyl groups with n=16 or octadecanoyl groups with n=18.

11. The magnetodielectric polymer composite according to claim 8, wherein said magnetodielectric polymer composite consists of 10 to 80 wt % of the at least one apolar polymer, 20 to 90 wt % of the particles having soft-magnetic properties and 0.1 to 10 wt % of amphiphilic hyperbranched polyethylenimines.

12. The magnetodielectric polymer composite according to claim 1, wherein the polymer matrix comprises one or more apolar polymers having a dielectric attenuation tan δ_{ε}<0.02.

13. The magnetodielectric polymer composite according to claim 12, wherein the polymer matrix comprises one or more apolar polymers having a dielectric attenuation tan δ_{ε}<0.01.

14. The magnetodielectric polymer composite according to claim 1, wherein the apolar polymers of the matrix are polyolefins, styrene-containing polymers, polyoxymethylene (POM), polyesters, polycarbonate (PC), polyphenylene ethers (PPE), polyphenylene oxides (PPO), polyphenylene sulfide (PPS), fluorine-containing polymers, thermoplastic elastomers, one-component solid-silicone elastomers, liquid two-component silicone rubbers (liquid silicone rubber, LSR), ethylene-propylene-diene rubbers (EPDM), epoxy resin casting compounds and/or acrylate ester-containing epoxy resins.

15. The magnetodielectric polymer composite according to claim 14, wherein the polyolefins are cyclic olefin polymers (COP), cyclic olefin copolymers (COC), polyethylene (PE) or polypropylene (PP); the styrene-containing polymers are polystyrene (PS), impact-modified polystyrene or acrylonitrile-butadiene-styrene copolymers (ABS); the polyesters are polyethylene terephthalate (PET), polybutylene terephthalate (PBT) or polyethylene naphthalate (PEN); the fluorine-containing polymers are polytetrafluoroethylene (PTFE), polyvinylidene fluoride (PVDF), perfluoro(ethylene-propylene) (FEP) or ethylene-tetrafluoroethylene copolymers (ETFE); the thermoplastic elastomers are polyether-block-amides (PEBA); the one-component solid-silicone elastomers are room temperature-crosslinking (RTV) or high temperature-crosslinking (HTV) silicone rubbers; the liquid two-component silicone rubber is polydimethylsiloxane; and the epoxy resin casting compounds are cold- or hot-curing epoxy.

16. The magnetodielectric polymer composite according to claim 15, wherein the impact-modified polystyrene is high-impact polystyrene (HIPS).

17. A process for producing the magnetodielectric polymer composite according to claim 1, comprising
mixing individual constituents with one another by compounding or by providing a dispersion comprised of a solution of the at least one apolar polymer, the particles having soft-magnetic properties and the amphiphilic hyperbranched spacer molecules in solvent and subsequently removing the solvent.

18. The process for producing the magnetodielectric polymer composite according to claim 17, wherein said compounding comprises mixing in an extruder or a kneader.

19. The process for producing the magnetodielectric polymer composite according to claim 17, further comprising processing the compounded or dried polymer composite by a shaping process selected from injection moulding, injection-compression moulding, compression moulding, extrusion or resin casting.

20. The process for producing the magnetodielectric polymer composite according to claim 19, wherein the shaping process produces magnetodielectric polymer composite in a form suitable for 3D printing.

21. The process for producing a magnetodielectric polymer composite according to claim 20, wherein the form suitable for 3D printing is filaments, pellets, powders, liquid resins or liquid silicone elastomers.

22. An antenna comprising a magnetodielectric polymer composite according to claim 1, wherein the magnetodielectric polymer composite ensheaths the antenna and the antenna operates in the frequency range from 50 MHz to 4 GHz.
